(19) United States
(12) Patent Application Publication
(10) Pub. No.: US 2010/0067708 A1
(43) Pub. Date: Mar. 18, 2010

(54) SYSTEM AND METHOD FOR AUTOMATICALLY UPDATING PRESENCE INFORMATION BASED ON SOUND DETECTION

(75) Inventor: Henrik Groth, Sollentuna (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/211,267

(22) Filed: Sep. 16, 2008

(51) Int. Cl. H04R 29/00

(52) U.S. Cl. 381/56

(57) ABSTRACT

A system, method and computer program that utilizes sound detection circuitry to automatically update presence information associated with portable electronic equipment. Aspects of the present invention provide reliable presence information regarding the availability of the user based on sounds detected at or near the electronic equipment.

### TECHNICAL FIELD OF THE INVENTION

The present invention relates generally to portable electronic equipment and, more particularly, to a portable electronic device that utilizes sound detection circuitry to automatically update presence information associated with the portable electronic device.

### DESCRIPTION OF THE RELATED ART

Mobile and/or wireless electronic devices are becoming increasingly popular. For example, mobile telephones, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces. With all of these features, such devices are generally available to the user at all times of the day (e.g., day and night) and on all occasions (e.g., business and personal use).

### SUMMARY

A system, method and computer program that utilizes sound detection circuitry to automatically update presence information associated with the portable electronic equipment. Aspects of the present invention provide reliable presence information regarding the availability of the user based on sounds sampled by the sound detection circuitry of the electronic equipment (also referred to herein as electronic device). The availability of reliable presence information will significantly increase the usage of presence information.

One aspect of the invention relates to an electronic device including: a memory for storing sound identification information; sound detection circuitry configured to detect sounds at or near the electronic device; and a processor coupled to the sound detection circuitry and the memory, wherein the processor processes the detected sound to determine a presence value associated with the electronic device for output to an associated network.

Another aspect of the invention relates to the sound detection circuitry being a microphone.

Another aspect of the invention relates to the sound detection circuitry periodically detecting sound when the electronic device is in a standby state.

Another aspect of the invention relates to the electronic device including radio circuitry coupled to the processor, wherein the radio circuitry may output the presence value to the associated network.

Another aspect of the invention relates to the processor also processing at least one of calendar information or time information stored in the memory to determine the presence value.

Another aspect of the invention relates to the processor comparing the detected sounds with sound identification information stored in the memory.

Another aspect of the invention relates to the processor outputting the presence value that includes information based on the sound identification information stored in the memory.

Another aspect of the invention relates to the processor receiving sound identification information from a remote source and outputs the presence value based on the received sound identification information received from the remote source.

Another aspect of the invention relates to the electronic device being a portable communication device.

One aspect of the invention relates to a method for updating presence information for an electronic equipment, the method including: detecting one or more sounds sensed at or near the electronic equipment; identifying the one or more detected sounds; processing the detected one or more sounds and the identification of the detected sound to determine a presence value associated with the electronic equipment; and outputting the presence value to an associated network.

Another aspect of the invention relates to the processor comparing the detected one or more sounds with sound identification information stored in the memory.

Another aspect of the invention relates to the step of identifying the one or more detected sounds including transmitting a request from the electronic equipment to a remote source over a network.

Another aspect of the invention relates to the request including at least a portion of the one or more sounds detected at or near the electronic equipment.

Another aspect of the invention relates to receiving a remote identification from the remote source of the one or more sounds detected based on the request.

Another aspect of the invention relates to processing the detected one or more sounds and the remote identification to determine a presence value associated with the electronic equipment.

Another aspect of the invention relates to the presence value varying as a function of the one or more detected sounds.

Another aspect of the invention relates to the presence value also varying as a function of at least one of calendar information and/or time information stored in the memory.

Another aspect of the invention relates to the presence value being automatically updated.

Another aspect of the invention relates to the presence value being updated when the presence value changes from a first state to a second state.

One aspect of the invention also relates to a computer program stored on a machine readable medium in an electronic device, the program including being suitable for processing one or more detected sounds detected by sound detection circuitry and identifying the one or more detected sounds to determine a presence value associated with the electronic device and outputting the presence value to an associated presence server, wherein the presence value is indicative of the detected sound and/or the identification of the one or more detected sounds.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of one embodiment of a mobile telephone as an exemplary electronic device in accordance with the present invention.

FIG. 2 is a schematic block diagram of the relevant portions of the mobile telephone of FIG. 1.

FIG. 3 is a schematic diagram of a communications system in which the mobile telephone of FIG. 1 may operate.

FIG. 4 is a flow chart representing an exemplary method of updating presence information in accordance with aspects of the present invention.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smartphones, portable communication apparatus or the like.

In the present application, embodiments of the invention are described primarily in the context of a mobile telephone. However, it will be appreciated that the invention is not intended to be limited to the context of a mobile telephone and may relate to any type of appropriate electronic equipment, examples of which include a media player, a gaming device and a computer.

Presence information is increasing in importance due to the expanding use of modern communications such as mobile phones, e-mail, instant messaging (IM) (e.g., chat sessions), etc. One benefit of having reliable presence information available to other users is the user that wants to initiate communication with someone can get a better understanding of whether the receiving user or users are available for communication. For example, the user that initiates communication can determine the appropriate time to contact a user based upon the presence information.

Conventionally, presence information has been used in instant messaging (e.g., chat applications) to see if the receiving user is at his desktop (e.g., “available”) or not (e.g., “away”). One problem with conventional presence values is that they are not updated automatically, which substantially limits the usefulness of such information. Generally, presence information is manually entered by the user. For example, a user would be required to set the presence value to “away” before leaving the desktop computer. Some conventional applications provide rudimentary functionality to automatically set a presence value. For example the “away status” on a desktop computer can be set when the user has not interacted with the computer for a predefined period of time (e.g., five minutes) or when the screen saver is active. This leads to a much heavier usage of the away presence status than if every user should have need to manually set the presence to away before leaving the computer. However, such conventional methods are still primitive and provide little useful information to other networked users. Another disadvantage is that conventional presence information is not based on sounds detected at near the electronic device.

In order to make presence information increasingly useful, aspects of this invention relate to an electronic equipment, method and computer program for automatically detecting sounds occurring at or near the electronic device and optionally identifying the sound to determine a presence value associated with the electronic equipment. In one embodiment, the presence value may include an identification of the sound detected at or near the electronic equipment. As a result of automatic presence value determination being based on sounds detected at or near the electronic device and optionally identifying the sound to determine presence values, presence values provide a reliable indicator to the availability of users. Accordingly, there will be a substantial increase in the usage of presence information.

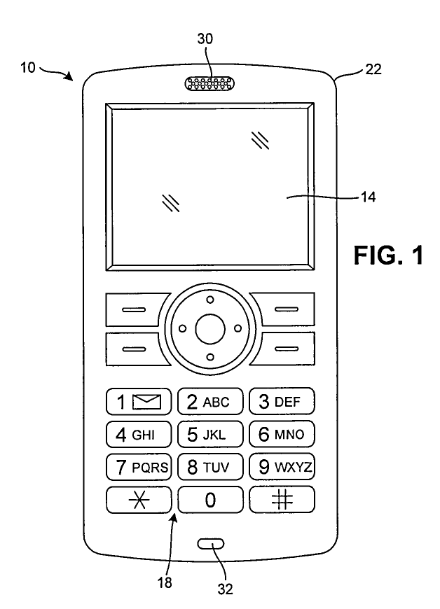

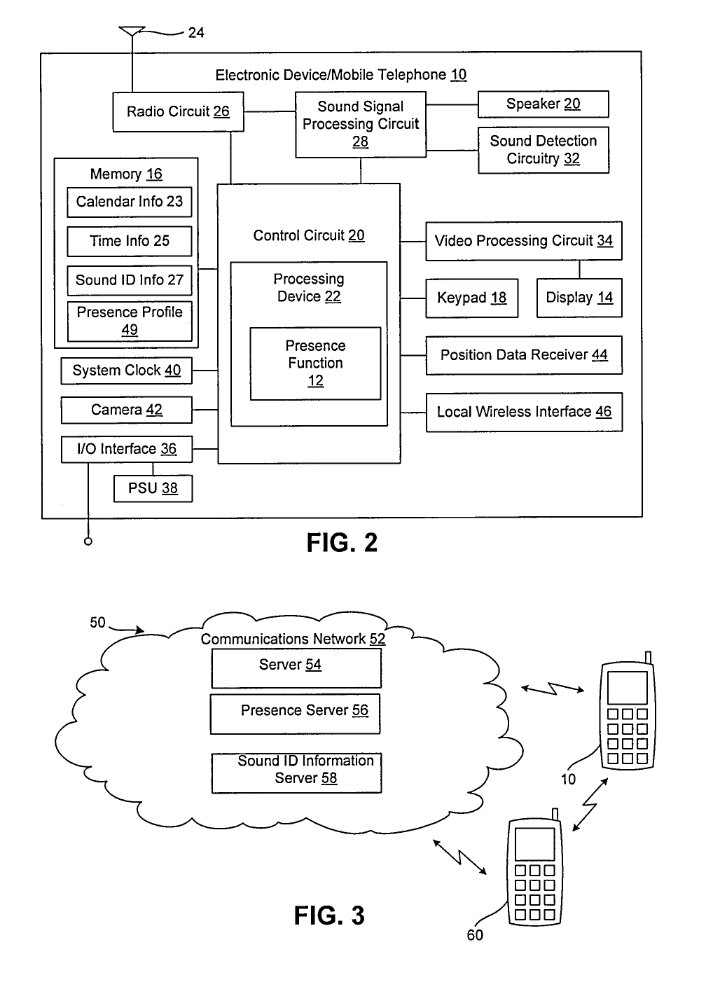

Referring initially to FIGS. 1 and 2, an exemplary portable electronic device 10 is shown. The electronic device 10 is configured with sound detection circuitry that samples sounds occurring in the environment at or near the electronic device 10. The sound detection circuitry converts the analog sound to an electric signal that is converted by an analog to digital converter, within the sound detection circuitry or externally from the sound detection circuitry, and outputs one or more corresponding digital signals of the detected sound. The electronic device 10 processes the digital signals to identify the detected sound. The detected sound may be compared to sounds stored internally, for example, in a memory or a request may be made to a remote server to identify the detected sound to determine a presence value for the electronic device. The presence value for the electronic device is output to a presence server so that individuals interested in contacting the user of the electronic device may view the presence information to determine if it is appropriate to contact the user.

The electronic device 10 may include a presence function 12 that is configured to determine the presence value of the electronic device. Additional details and operation of the presence function 12 will be described in greater detail below. The presence function 12 may be embodied as executable code that is resident in and executed by the electronic device 10. In one embodiment, the presence function 12 may be a program stored on a computer or machine readable medium. The presence function 12 may be a stand-alone software application or form a part of a software application that carries out additional tasks related to the electronic device 10. The presence function 12 may be stored in memory 16 and/or in firmware, as discussed below.

The electronic device of the illustrated embodiment is a mobile telephone and will be referred to as the mobile telephone 10. The mobile telephone 10 is shown as having a “brick” or “block” form factor housing, but it will be appreciated that other housing types may be utilized, such as a “flip-open” form factor (e.g., a “clamshell” housing) or a slide-type form factor (e.g., a “slider” housing).

The mobile telephone 10 may include a display 14. The display 14 displays information to a user such as operating state, time, telephone numbers, contact information, various navigational menus, etc., through a graphical user interface (GUI) that enables the user to utilize the various features of the mobile telephone 10. The display 14 also may be used to visually display content received by the mobile telephone 10 and/or retrieved from a memory 16 (FIG. 2) of the mobile telephone 10. The display 14 may be used to present images, video and other graphics to the user, such as photographs, Internet content, presence information, etc.

A keypad 18 provides for a variety of user input operations. For example, the keypad 18 typically includes alphanumeric keys for allowing entry of alphanumeric information such as telephone numbers, phone lists, contact information, notes, etc. In addition, the keypad 18 typically includes special function keys such as a “call send” key for initiating or answering a call, and a “call end” key for ending or “hanging up” a call. Special function keys also may include menu navigation and select keys to facilitate navigating through a menu displayed on the display 14. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 18 may be used in conjunction with one another to implement soft key functionality.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 10 may be configured to transmit, receive and/or process data, such as text messages (e.g., a text message is commonly referred to by some as “an SMS,” which stands for simple message service), instant messages, electronic mail messages, multimedia messages (e.g., a multimedia message is commonly referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth.

FIG. 2 represents a functional block diagram of the mobile telephone 10. For the sake of brevity, generally conventional features of the mobile telephone 10 will not be described in great detail herein. The mobile telephone 10 includes a primary control circuit 20 that is configured to carry out overall control of the functions and operations of the mobile telephone 10. The control circuit 20 may include a processing device 22, such as a CPU, microcontroller or microprocessor. The processing device 22 executes code stored in a memory (not shown) within the control circuit 20 and/or in a separate memory, such as the memory 16, in order to carry out operation of the mobile telephone 10. The memory 16 may be, for example, one or more of a buffer, a flash memory, a hard drive, a removable media, a volatile memory, a non-volatile memory, a random access memory (RAM), or other suitable device.

The memory 16 may include calendar information 23. Calendar information 23 may include any information related to a calendar application. Such information may include, for example, appointments, description of appointments, location of appointments, contact information associated with appointment, time of appointment, duration of appointment, tasks, etc. The calendar information 23 may also be stored remotely, for example, on an external server. The calendar information 23 may be provided from any suitable calendar application (e.g., Microsoft Outlook, Google Calendar, GroupWise Calendar, Yahoo Calendar, etc.). The memory 16 may also include time information 25. The time information may include any type of time related information. Such information may include, for example, time of day, time till next appointment, time in current communication state, expected duration of appointment, etc. While shown as separate information entities, one of ordinary skill in the art will readily appreciate that time information and calendar information may be stored jointly in a single data structure.

The memory 16 also includes sound identification information 27. Sound identification information 27 may include any information that may be used to identify sounds that may be detected at or near the mobile telephone 10. Such information may include, for example, music tracks, movie tracks, television sounds, common sounds heard outside, voice recognition, etc. The sound identification information 27 may also be stored remotely, for example, on an external server (e.g., on a TrackId® server, which facilitates recognition of music from the mobile telephone or external sources, and displays information about that music on the mobile telephone). The sound identification information 27 may be provided from any suitable source, such a database of sounds. In addition, the sound identification information 27 may be tailored to a user's use of the mobile telephone (e.g., by the user training the device, for example, by sampling sounds and defining activities associated with the sampled sounds.). In such examples, the identification process generally takes an unknown sound signal (e.g., a sound detected at or near the mobile telephone 10) and compares the unknown sound signal with known sound signals to identify the unknown sound signal.

The processing device 22 may execute code that implements the presence function 12. It will be apparent to a person having ordinary skill in the art of computer programming, and specifically in application programming for mobile telephones or other electronic devices, how to program a mobile telephone 10 to operate and carry out logical functions associated with the presence function 12. Accordingly, details as to specific programming code have been left out for the sake of brevity. Also, while the presence function 12 is executed by the processing device 22 in accordance with a preferred embodiment of the invention, such functionality could also be carried out via dedicated hardware, firmware, software, or combinations thereof, without departing from the scope of the invention.

Continuing to refer to FIGS. 1 and 2, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 28 for processing audio signals transmitted by and received from the radio circuit 26. Coupled to the sound processing circuit 28 are a speaker 30 and sound detection circuitry 32 (e.g., a microphone) that enable a user to listen and speak via the mobile telephone 10 as is conventional. The sound detection circuitry 32 is described further below.

The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream that is received by the radio circuit 28 or obtained by any other suitable method.

The mobile telephone 10 may further include one or more I/O interface(s) 36. The I/O interface(s) 36 may be in the form of typical mobile telephone I/O interfaces and may include one or more electrical connectors. As is typical, the I/O interface(s) 36 may be used to couple the mobile telephone 10 to a battery charger to charge a battery of a power supply unit (PSU) 38 within the mobile telephone 10. In addition, or in the alternative, the I/O interface(s) 36 may serve to connect the mobile telephone 10 to a headset assembly (e.g., a personal handsfree (PHF) device) that has a wired interface with the mobile telephone 10. Further, the I/O interface(s) 36 may serve to connect the mobile telephone 10 to a personal computer or other device via a data cable for the exchange of data. The mobile telephone 10 may receive operating power via the I/O interface(s) 36 when connected to a vehicle power adapter or an electricity outlet power adapter.

The mobile telephone 10 also may include a system clock 40 for clocking the various components of the mobile telephone 10, such as the control circuit 20. The control circuit 20 may, in turn, carry out timing functions, such as timing the durations of calls, generating the content of time and date stamps, and so forth.

The mobile telephone 10 may include a camera 42 for taking digital pictures and/or movies. Image and/or video files corresponding to the pictures and/or movies may be stored in the memory 16. The mobile telephone 10 also may include a position data receiver 44, such as a global positioning system (GPS) receiver, Galileo satellite system receiver or the like.

The mobile telephone 10 also may include a local wireless interface 46, such as an infrared transceiver and/or an RF interface (e.g., a Bluetooth interface), for establishing communication with an accessory, another mobile radio terminal, a computer or another device. For example, the local wireless interface 46 may operatively couple the mobile telephone 10 to a headset assembly (e.g., a personal hands-free device) in an embodiment where the headset assembly has a corresponding wireless interface.

As discussed above, the mobile telephone 10 includes sound detection circuitry 32. The sound detection circuitry may be any type of circuitry that is capable detecting and/or acquiring sound signals that occur at or near the mobile telephone 10. For example, the sound detection circuitry 32 may be a microphone. The phrase “sound detection circuitry” is intended to be interpreted broadly to include any type of sensor, any number of sensors and/or any arrangement of sensors that is capable of detecting sound occurring at or near the mobile telephone 10. The sound detection circuitry 32 may constantly and/or periodically detect sounds occurring at or near the mobile telephone 10. In one embodiment, the sound detection circuitry periodically detects sound when the mobile telephone is in a “standby” state. As used herein, the “standby” state means that the user is not actively engaged in a voice call with the mobile telephone.

The sound detection circuitry 32 may be located in any desirable position on the mobile telephone 10. In addition, the sound detection circuitry may be a remote device that may be coupled to the mobile telephone 10 through a cable, for example. The location of the sound detection circuitry 32 may vary based on a number of design considerations. Such design considerations include, for example, the type of sensors used, the number of sensors, the size and shape of the electronic equipment, etc. For example, if there is only one sound detection circuitry 32 on the mobile telephone, which must be used for voice communications, as well as to detect sounds occurring at or near the mobile telephone 10, it may be desirable to place the sound detection circuitry in position that is convenient for the use to hold the mobile telephone for listening and placing the sound detection circuitry in a position near the position that the user's mouth will normally be present. If there are multiple sound detection circuits, it may be desirable to place such circuits in positions to maximize the reception of sound signals from all directions.

With additional reference to FIG. 3, the mobile telephone 10 may be configured to operate as part of a communications system 50. The system 50 may include a communications network 52 having a server 54 (or servers) for managing calls placed by and destined to the mobile telephone 10, transmitting data to the mobile telephone 10 and carrying out any other support functions. The communications network 52 may also include a presence server 56. The presence server 56 is operable to provide information usable by electronic devices (e.g., electronic devices 10, 60) that are coupled to the communication network 50 to determine presence values associated with users on the network. As used herein, the term “presence server” includes any applicable application server capable of providing presence information (e.g., at least location information for portable communication devices), as discussed below. For purposes of this discussion, the term “presence server” may be replaced with location server without departing from the scope of the present invention. In addition, the presence server may be combined with one or more other servers to provide the functionality described herein. For example, the server 54 may also function as a presence server even though it also supports one or more other call functions.

The system 50 also may include a sound identification server 58 as part of the communications network 52. The sound identification server 58 may receive requests from the mobile telephones 10, 60 to identify one or more detected sound signals that were detected at or near the mobile telephone 10, 60. For example, the sound identification server 58 may include a repository of sound identification information, including, for example, songs, titles of songs, names of artists, movies, names of actors, sounds, noises, etc, which have been previously identified. The sound identification server may receive requests from one or mobile telephones. The request may include sounds or portions of sounds detected at or near the mobile telephones 10, 60. Upon receipt of a request, the server 58 compares the unknown received sound signals with the sound identification information contained on the sound identification server 58. If a match between the detected sound is determined by the server 58, the server transmits an identification of the sound to the mobile telephone that originated the request. The mobile telephone 10, 60 may then store the identification locally in memory 16, so that another remote request for the identified sound is unnecessary. Therefore, when a known sound is stored locally, a remote request does not have to be made to the sound identification server 58 to identify the detected sound. If the server 58 is unable to identify the detected sound, the user may be given the opportunity to train or otherwise define the sound and store such information in the mobile telephone 10 and/or the sound identification server 58.

The server 54, presence server 56, and sound identification server 58 communicate with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 52 may support the communications activity of multiple mobile telephones 10, 60 and other types of end user devices. As will be appreciated, the servers 54, 56, and 58 may be configured as a typical computer system used to carry out server functions and may include a processor configured to execute software containing logical instructions that embody the functions of the servers 54, 56, 58 and a memory to store such software.

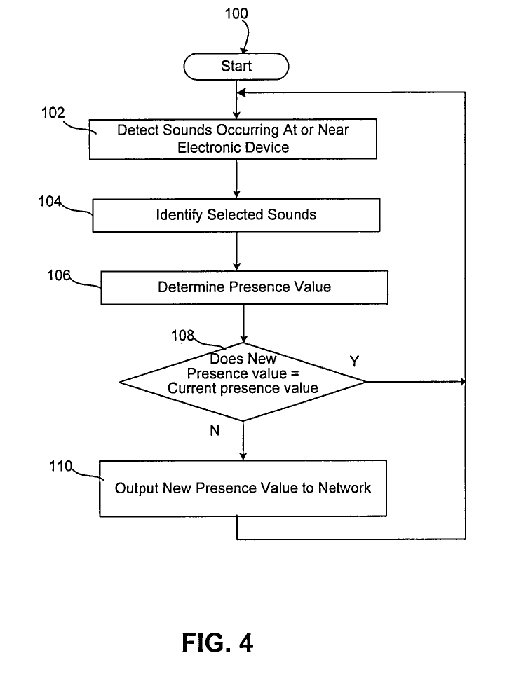

With additional reference to FIG. 4, illustrated are logical operations to implement an exemplary method 100 for updating presence information for associated with the mobile telephone 10. At block 102, sound (e.g., one or more sound signals) is detected occurring at or near the mobile telephone 10. Sound is detected by the sound detection circuitry 32.

At block 104, the one or more detected sounds are identified. The identification process may include searching sound identification information 27 stored in memory 16 and/or sending a request to a remote server (e.g., sound identification server 58) to identify the detected one or more sounds. The step of identifying the one or more detected sounds may also include transmitting a request from the electronic equipment to a remote source over a network. The request includes at least a portion of the one or more sounds detected at or near the electronic equipment. In one embodiment, the request is made to the remote source only after the sound identification information 27 in memory has been searched and is unable to identify the detected sound signals.

At block 106 a presence value associated with the mobile telephone 10 is determined. Generally, the presence value is determined by processing the detected sound and/or an identification information associated with the detected sound to determine a presence value to be assigned to the mobile telephone. The presence function 12 generally processes the identification from memory 16 and/or server 58 to determine a presence value for the electronic device 10. The presence value also may be determined by processing the detected sound and/or identification information associated with the detected sound with calendar information 23 and/or time information 25. For example, the presence function 12 may processes the detected sound and/or the identification information with calendar information 23 and/or time information 25 to determine a presence value for the mobile telephone 10.

The determination of the presence value may be based on a presence profile 49, which is stored in memory. The presence profile 49 may have predetermined designations for presence values and/or user defined designations that may be output as presence values. The presence profile 49 may be in the form of a database, look-up-table (LUT), etc. The presence profile 49 may include columns having one or more predetermined values based on sound identification, calendar information and/or time information. For example, the presence profile 49 may include values that correspond to detecting songs being played at near the mobile telephone. Such a value may indicate “listening to music”, “at a concert”, “driving home listening to “Vertigo” by U2”. Other examples include lines spoken by an actor in a movie, sounds encountered while playing video games, environmental sounds, etc.

The presence profile 49 may include values that correspond to various detected sounds. For example, lyrics from a song may be associated with the user being in a car, in a club, etc. In one embodiment, the presence profile 49 processes the detected sound and optionally calendar information 23 and/or time information 25 in a predefined manner and/or user defined manner to determine a presence value. For example, the identified sound, calendar information (optional) and time information (optional) may be compared with a predetermined data stored in the presence profile to determine an appropriate presence value for the mobile telephone.

The presence profile 49 may obtain information directly from the calendar information 23 and/or time information 25 at any desired time. For example, the calendar information 23 and time information 25 may be populated directly into the presence profile 49 when entered or otherwise acquired. In another embodiment, the calendar information 23 and the time information may be periodically obtained by the presence profile 49 for use in determining a presence value for the electronic device.

At block 108, a determination is made as to whether the new presence value is the same as the previous presence value. If the new presence value is equal to the previous presence value, processing returns to block 102. If the new presence value is not the same as the previous presence value, the new presence value is output to the presence server 54 at block 110, so that the presence value associated with the mobile device may be accessible to other electronic devices (e.g., electronic device 60) that have access to the network 52. Thus, the presence value may be updated when the presence value changes from a first state to a second state. After the presence value has been updated to the network, data flows returns to block 102 for automatically and continuously monitoring for sound detected at or near the electronic device, calendar information and time information. Presence values may be updated continuously, at predefined times, upon the occurrence of predefined events, etc.

The presence profile 49 may obtain information directly from the calendar information 23 and/or time information 25 at any desired time. For example, the calendar information 23 and time information 25 may be populated directly into the presence profile 49 when entered or otherwise acquired. In another embodiment, the calendar information 23 and the time information may be periodically obtained by the presence profile 49 for use in determining a presence value for the electronic device.

Based on the above exemplary method 100, an exemplary use case is presented. User A is using MSN Messenger or another instant messenger application with his mobile phone and the user has enabled sound presence detection. When User A turns on a stereo to listen to music while having dinner, mobile telephone 10 sets a presence value to “Listening to Music”. In another embodiment, the presence value may be more precisely. For example, when User A is listening to “Beautiful Day” by U2, the presence value may read: “Listening to Beautiful Day by U2” or another suitable designation. After dinner, User A may begin to play a video game (e.g., Halo, FIFA Soccer, Madden Football, etc.) on his game console (e.g., PlayStation, X-Box, Wii, etc.). The presence value may updated based on the sounds detected at or near the mobile telephone. For example, the presence value may be set to “Playing video games”. In another embodiment, the presence value may actually state the game being played. For example, if User A is playing the video game Halo, the presence value may be set to “Playing Halo” or some other suitable designation. User B has just completed a workout and is on his or her way home. User B views his or her mobile telephone displaying MSN messenger and determines that the presence status for User B is “Playing Halo”. Based on this information, User B may initiate a telephone call to User A. For example, User B might call User A and inquire as follows: “Hey, I saw you are playing Halo, might I come over and join you?”.

Another exemplary use case is presented below. User A is out dancing with friends on a weekend night at a night club. User A's mobile telephone has enabled sound presence and thus, constantly updates User A's presence information according to the music played at the night club. User B is also at a night club hanging out with friends. When User B's friend leaves User B for a few minutes, User B views his mobile telephone and looks on his buddy list associated with MSN Messenger, for example. Since User B's mobile telephone is equipped with sound presence he realizes that he is listening to the same music as User A and that they may be at the same night club. User B may send User A a text message or call User A enabling the User A and User B to meet up at the club, for example.

Based on the above example, one of ordinary skill in the art can readily appreciate that the presence value may vary as a function of detected sounds, a function of calendar information, a function of time information and/or a combination one or more these items. In addition, the presence value may be updated continuously, at predefined times or upon detected events.

The exemplary method may be carried out by executing an embodiment of the presence function 12, for example. Thus, the flow chart of FIG. 4 may be thought of as depicting steps of a method carried out by the electronic device 10. Although FIG. 4 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. An electronic device comprising:
a memory for storing sound identification information;
sound detection circuitry configured to detect sounds at or near the electronic device; and
a processor coupled to the sound detection circuitry and the memory, wherein the processor processes the detected sound to determine a presence value associated with the electronic device for output to an associated network.

2. The electronic device of claim 1, wherein the sound detection circuitry is a microphone.

3. The electronic device of claim 1, wherein the sound detection circuitry periodically detects sound when the electronic device is in a standby state.

4. The electronic device of claim 1 further including radio circuitry coupled to the processor, wherein the radio circuitry may output the presence value to the associated network.

5. The electronic device of claim 1, wherein the processor also processes at least one of calendar information or time information stored in the memory to determine the presence value.

6. The electronic device of claim 1, wherein the processor compares the detected sounds with sound identification information stored in the memory.

7. The electronic device of claim 6, wherein the processor outputs the presence value that includes information based on the sound identification information stored in the memory.

8. The electronic device of claim 1, wherein the processor receives sound identification information from a remote source and outputs the presence value based on the received sound identification information received from the remote source.

9. The electronic device of claim 1, wherein the electronic device is a portable communication device.

10. A method for updating presence information for an electronic equipment, the method comprising:
detecting one or more sounds sensed at or near the electronic equipment;
identifying the one or more detected sounds; and
processing the detected one or more sounds and the identification of the detected sound to determine a presence value associated with the electronic equipment; and
outputting the presence value to an associated network.

11. The method of claim 10, wherein processor compares the detected one or more sounds with sound identification information stored in the memory.

12. The method of claim 10, wherein the step of identifying the one or more detected sounds includes transmitting a request from the electronic equipment to a remote source over a network.

13. The method of claim 12, wherein the request includes at least a portion of the one or more sounds detected at or near the electronic equipment.

14. The method of claim 13 further including receiving a remote identification from the remote source of the one or more sounds detected based on the request.

15. The method of claim 14 further including processing the detected one or more sounds and the remote identification to determine a presence value associated with the electronic equipment.

16. The method of claim 10, wherein the presence value varies as a function of the one or more detected sounds.

17. The method of claim 16, wherein the presence value also varies as a function of at least one of calendar information and/or time information stored in the memory.

18. The method of claim 10, wherein the presence value is automatically updated.

19. The method of claim 10, wherein the presence value is updated when the presence value changes from a first state to a second state.

20. A computer program stored on a machine readable medium in an electronic device, the program including being suitable for processing one or more detected sounds detected by sound detection circuitry and identifying the one or more detected sounds to determine a presence value associated with the electronic device and outputting the presence value to an associated presence server, wherein the presence value is indicative of the detected sound and/or the identification of the one or more detected sounds.
